(19) United States
(12) Patent Application Publication
(10) Pub. No.: US 2026/0358613 A1
(43) Pub. Date: Nov. 12, 2026

(54) A DEVICE AND A METHOD FOR SCANNING-FREE, DIFFRACTION- LIMITED, VOLUMETRIC IMAGING THROUGH LOCALIZED ILLUMINATION

(71) Applicant: Università degli Studi di Bari Aldo Moro, Bari (IT)

(72) Inventors: Milena D'ANGELO, Bari (IT); Francesco Vincenzo PEPE, Bari (IT); Gianlorenzo MASSARO, Bari (IT)

(21) Appl. No.: 19/471,855

(22) PCT Filed: Apr. 4, 2023
(86) PCT No.: PCT/IB2023/053402

§ 371 Date: Oct. 2, 2025

(51) Int. Cl. G02B 21/08; G02B 21/36

(52) U.S. Cl. CPC G02B 21/086; G02B 21/361; G02B 21/367

(57) ABSTRACT

An imaging system and a related method includes: providing an array of light sources outputting a light emission; providing an imaging unit including a focusing element and detector; providing an object between the detector and the array; providing an imaging device between the array and the object; operating the array by activating the light sources in a sequential pattern, whereby a position of an activated light source relative to the object is varied according to said sequential pattern; imaging the array through said imaging device; detecting a location at which images of points of said object form under disparate positions of the activated light sources and a shift of each detected location relative to a reference location; and reconstructing an image of the object by aligning the images of points of said object by offsetting the shift of each detected location relative to the reference location.

### FIELD OF THE INVENTION

The present invention relates to imaging devices and methods.

### PRIOR ART

Current techniques for three-dimensional imaging rely either on scanning of the sample of interest, or on modifying the optical apparatus in order to change the properties of the recorded image to include also information on the propagation direction of light rays (as opposed to conventional imaging wherein only intensity on a plane at focus is available). The main drawbacks of the first approach, namely, mechanical scanning of the sample, are the usually long acquisition time required for a thorough analysis of the sample, with the subsequent strict requests on stability, as well as all technical complications connected with optical devices with moving parts.

Scanning-free 3D imaging, on the other hand, is conventionally implemented in light-field (or plenoptic) devices by introducing an array of microlenses in a conventional optical apparatus. The array, required for retrieving the directional information needed for 3D reconstruction, has also the effect of reducing the resolution of the device. Particularly, the 3D imaging capability is inversely proportional to the resolution.

A solution to the aforementioned technical problems is available in the prior art and corresponds to the imaging system shown in FIGS. 1A and 1B and referenced as 1.

The imaging system 1 comprises an array SRC of light sources of plane waves (herein designated as S1, S2, Sk, S(k+1), Sn; in general a minimum of two light sources are envisaged), wherein each light source S1, S2, Sk, S(k+1), Sn (collectively referred to as “S1-Sn”) is configured for the output of a light emission (for simplicity, only light emission W1 and Wn associated to light sources S1 and Sn, respectively, are shown in FIGS. 1A and 1B instead of the full set W1, W2, Wk, W(k+1), Wn which are collectively referred to as “W1-Wn”). Each light source S1, S2, Sk, S (k+1), Sn is a source generating a plane wave having known inclination defined by its location x₀ on the light source array SRC.

The imaging system 1 includes an imaging unit 2 including a focusing element L0 placed in such a way that the plane FP, at a distance z₀ from the focusing element, is conjugated to a plane in which a detector DT is located. The detector DT is configured for detecting the light emissions from the light sources of the array SRC through the object OBJ and the focusing element L0. The imaging unit may also include an image acquisition device 4, such as a camera.

In other terms, the light emissions reach the detector DT by first passing through the focusing element L0 and forming images I1, I2, Ik, I(k+1), In collectively referred to as “I1-In”) of the object OBJ under the illumination angle from, respectively, sources S1-Sn and emission W1-Wn (the images from the full set of the emissions and light sources is not shown to avoid overcomplicating the drawing). The complete object shall be intended to be a three-dimensional object; indication of a planar object OBJ in the figures is intended as a (planar) “slice” of the overall 3D object. Similarly—this applying to all of the figures herein, whether relating to prior art configurations or embodiments of the invention—the light emissions I1—In as depicted in the figures represent a single light beam passing through the object OBJ, wherein the light beam is extracted from the overall light emission of the light sources S1-Sn. For example, if the light source concerned is a LED source with isotropic light emission pattern, the emissions I1-In are intended as a light beam out of the entire light emission pattern that passes through the object OBJ.

The detector DT is configured for allowing formation of the images I1-In at spatial locations thereon.

A control unit MC is configured for operating the array SRC by sequential activation of the light sources S1, S2, Sk, S(k+1), Sn to illuminate an object OBJ arranged between array SRC and the detector DT, and more specifically arranged between the array SRC and the focusing element L0, whereby an illumination angle of the object OBJ is varied with the sequential activation of the light sources S1, S2, Sk, S(k+1), Sn (again for simplicity, only illumination angles B1 and Bn associated to light sources S1 and Sn, respectively, are shown in FIGS. 1A and 1B).

As seen in FIG. 1, when the object OBJ lies at a distance z=z₀ from the focusing element L0, i.e. when the image of the object OBJ is on the plane FP (i.e., it is on focus on the detector DT), the spatial locations at which the light emissions W1-Wn hit the detector DT, hence, at which images I1-In form, coincide with each other, and so goes for the remainder of the light emissions from the sources of the array SRC.

More in detail, with reference to FIG. 1A, in case the object OBJ is positioned relative to the imaging unit 2 so that the plane thereof is coincident with the focusing plane FP (z=z₀), i.e. in case the object OBJ is on focus, the images I1-In of the centroid of the object OBJ are formed on the plane of the detector DT regardless of the illumination angle of the plane wave from the light source illuminating the object OBJ, whereby the spatial locations of the detector DT at which the images I1-In form is invariably the same without any shift with respect to an intersection x of the optical axis a of the system with the detector DT, as seen in FIG. 1A, wherein the intersection x is a reference spatial location.

Conversely, when the object OBJ is positioned relative to the imaging unit 2 so that the plane thereof is not coincident with the focusing plane FP (z≠z₀), the images I1-In of the centroid of the object OBJ do not coincide on the plane of the detector DT, whereby the spatial locations of the detector DT at which the images I1-In form are different and shifted with respect to the reference spatial location x, as seen in FIG. 1B. Such shifts are indicated as O1-On (again for the sake of simplicity, a full depiction of the offsets from the light sources in the array SRC is not provided), the extent of which depends on the illumination angle, viz. on the location x₀ of the light source that is activated, and the reference spatial location x.

The control unit MC is configured for operating the array of light sources S1, S2, Sk, S(k+1), Sn by activating the light sources S1, S2, Sk, S(k+1), Sn according to a sequential pattern, whereby an illumination angle of the object OBJ between the detector DT and the array of light sources is varied with the activation of the light sources S1, S2, Sk, S(k+1), Sn according to said sequential pattern. The control unit is also configured for detecting the spatial location at which images I1-In of points of the object OBJ form under the disparate illumination angles on the detector DT, and for determining a shift O1, O2, Ok, O(k+1), On (FIG. 1B, collectively referred to as “O1-On”) of each detected spatial location with respect to the reference spatial location x. Additionally, the control unit (MC) is configured for reconstructing an image of the object OBJ by aligning the images I1-In of points of the object OBJ formed under the disparate illumination angles (defined by the source location x₀) by offsetting the shifts O1-On of each detected spatial location with respect to the reference spatial location x.

The 3D reconstruction of the object OBJ is therefore achieved by processing information from a predetermined number of illumination angles, as defined by the source location x₀, the number depending on the number of light sources in the array SRC, and by applying an alignment algorithm—for each point of the object OBJ—to offset the shifts O1-On in the spatial location at which images I1-In of a point of the object OBJ form on the detector DT under varying illumination angles (i.e. under varying active light sources).

The control unit MC, in this regard, may also operate as a trigger for the detector DT and the light sources of the array SRC by synchronously operating the detector DT and the sources of the array SRC.

The prior art system extensively detailed in the foregoing does, however, does not fully exploit the advantage in optical performance deriving from coherent illumination, especially if a fine tuning of the system in view of specific applications is desired.

Additionally, in the prior art solutions plane wave illumination was considered as an essential requirement for the imaging system to work.

### OBJECT OF THE INVENTION

The object of the invention is to solve the above-mentioned technical problems. In particular, the object of the invention is to provide an imaging device and method to obtain images, particularly 3D images, with a high resolution, large depth of field, and fine axial localization, without the technical and timing difficulties of the conventional mechanical scanning, and provided with fine-tuning capabilities of the optical performances as well.

### SUMMARY OF THE INVENTION

The object of the invention is achieved by a device and a method having the features of the claims that follow, which form an integral part of the technical disclosure in relation to the invention.

### BRIEF DESCRIPTION OF THE FIGURES

Further features and advantages of the invention will become apparent from the following description with reference to the annexed figures, provided purely by way of non-limiting example, wherein:

FIGS. 1A, 1B are representative of two different general operating conditions in an imaging system according to the prior art

FIGS. 2, 3 schematically illustrate different embodiments of the imaging system according to the invention, and

FIGS. 4, 5 are representative of performance features of an imaging system according to the invention, as well as—for comparison—the prior art system of FIGS. 1A, 1B, and standard imaging performed by means of imaging systems not having 3D imaging capability.

### DETAILED DESCRIPTION

As a preliminary remark, an additional description of the physics of the optical system of the prior art with specific reference to aspects and features noted by the inventors, but completely overlooked in the prior art, will now be provided. Such aspects and features are also at the foundation of the embodiments of the invention, whereby the relevant disclosure conveyed thereby apply to the embodiments of the invention (systems 100, 200) as well.

The images I1, In of the object OBJ shall now be described by an intensity distribution I(x, x₀) thereof on the detector DT, and the object OBJ by its field transmission profile A(x). With this notation, the intensity distribution I(x, x₀) of the images I1-In of the object A(x) illuminated by a single point-like light source Sn placed at a known location x₀ on the array of light sources SRC, is given by the square modulus of the Green's function describing the light propagation in the optical setup from the array of light sources SRC to the detector DT:

I(x,x₀)=|S(x,x₀)*A(x)*D_{z-z0}(x)*P(x)|²; (1)

The symbol * denotes the convolution product, so that for two functions f and g, f(x)*g(x)=∫f(y)g(x−y)dy. The result of Equation (1) applies to the prior art, but does not require the light source Sn to be a source of plane waves of known inclination; in fact, any point-like light source placed at a known location x₀ on the array of light sources SRC results in an image described by Equation (1).

As will be discussed in the following, Equation (1) still applies when the source centered at coordinate x₀ has non-negligible transverse size, provided the dimension of the coherence area of the light emission onto the object OBJ is larger than the object itself.

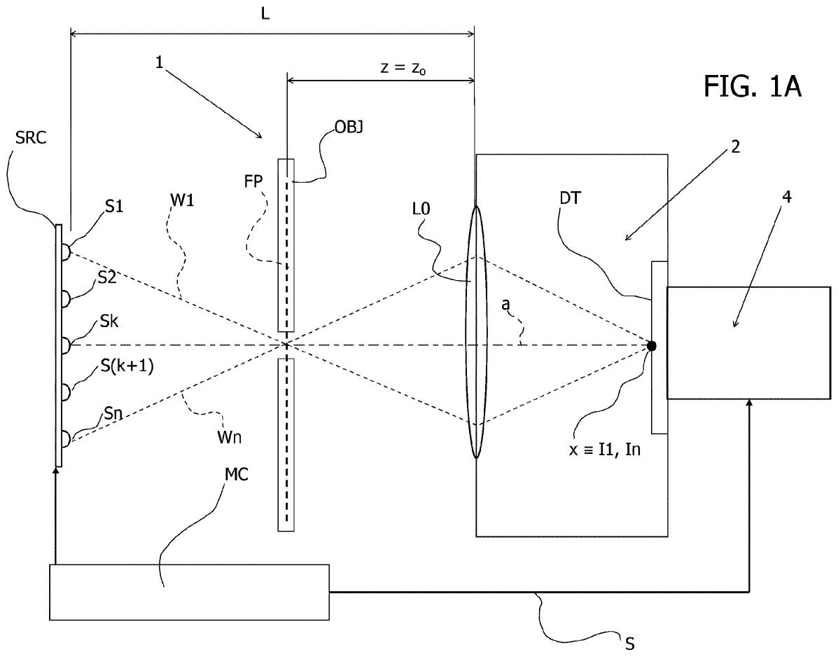

The illumination scheme of each imaging system in FIGS. 1-3 only defines the functional form of S(x, x₀), which represents the Green's function propagating the electric field of the light emission Wn from the light source Sn of the array SRC to the object OBJ. In Equation (1), D_{z-z0}(x)*P(x) is the point-spread-function (PSF) of the out-of-focus imaging system, comprising the PSF of the focused imaging system P(x) (i.e. the PSF associated with the plane at focus FP) and a defocusing term D_{z-z0}(x), describing the propagation of light emission Wn from the plane at focus FP to the object OBJ placed at a distance z from the focusing element L0.

Equation (1) indicates that the image formed by each single light source S1, S2, Sk, S(k+1), Sn through the focusing element L0 on the detector DT and recorded by the camera 4, as the light source location x₀ is varied—i.e., as the activated light source is varied—is a coherent image of the object OBJ.

If the (coherent) images produced by the light sources S1, S2, Sk, S(k+1), Sn on the array SRC, separately activated, are summed together without any prior processing (or, equivalently, if all light sources S1, S2, Sk, S(k+1), Sn are turned on simultaneously during a single acquisition of the camera 4), independently of the illumination scheme (FIG. 1, 2, 3), one obtains the well-known (hereafter referred as standard) incoherent image

$${I}_{foc} ( x ) = {\sum }_{all {x}_{0}} I ( x , {x}_{0} ) = {\vert A ( x ) \vert}^{2} * {\vert {D}_{z - {z}_{0}} ( x ) * P ( x ) \vert}^{2} . \qquad ( 2 )$$

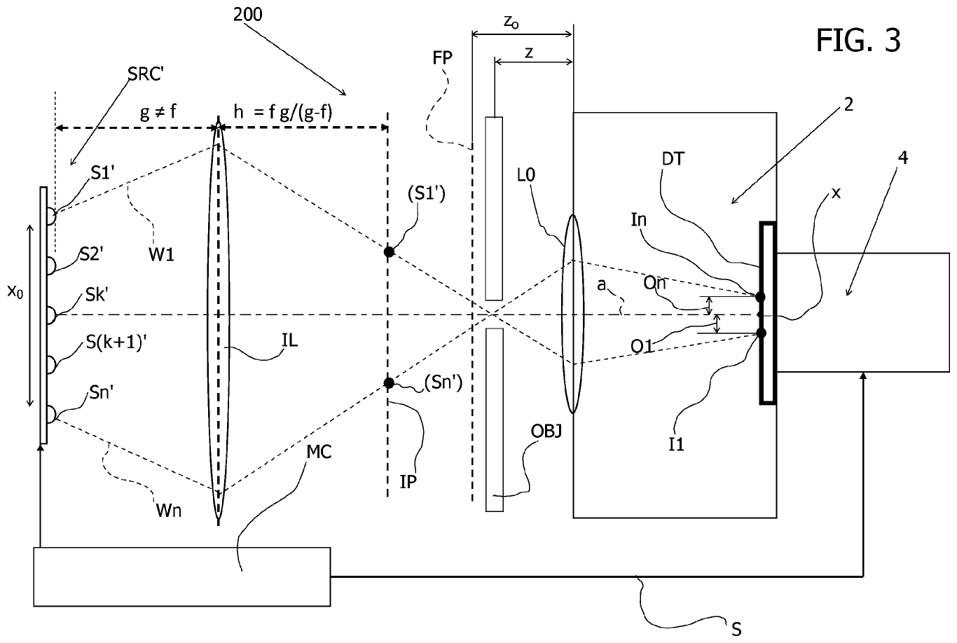

If the object OBJ is at focus (z=z₀, D_{z0-z0}=1), the resolution of the incoherent image of Equation (2) above is the so-called Rayleigh limit, determined by the PSF at focus P(x), ultimately defined by the numerical aperture (NA) of the imaging system. If z≠z₀, the summation in Equation (2) yields a blurred incoherent image. In fact, the effect of defocusing is to shift each coherent image I1-In (having—as indicated—a light intensity distribution I(x, x₀)), by a x₀-dependent quantity, i.e. by a quantity ultimately dependent on the location of the activated light source in the array SRC. As an example, such a quantity corresponds to shifts O1-On in FIG. 1B, with reference to the illumination scheme of the imaging system in FIG. 1a. The out-of-focus resolution of the incoherent image of Equation (2) is determined by the geometrical circle of confusion, which induces a linear NA-dependent scaling of the resolution of the standard incoherent image as a function of the defocusing distance z-z₀ (see FIG. 4—“STD” plot).

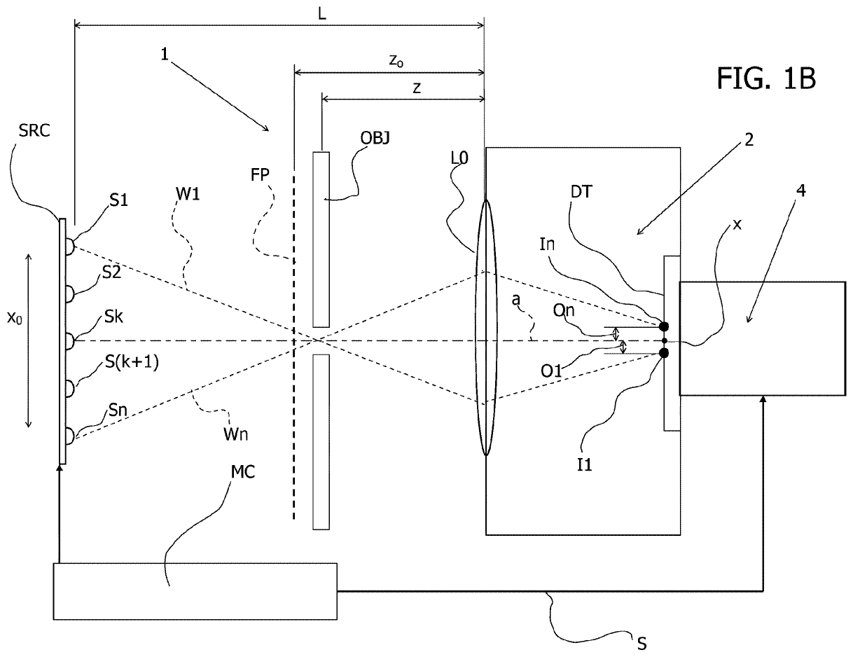

Both in the prior art (FIG. 1A, 1B) and in the invention (FIG. 2, 3), the focused image of an object OBJ located in a plane different from the plane at focus FP (i.e., located at a distance z from the focusing element L0 different from z₀) are reconstructed by applying a Radon transform to the coherent images I1-In of Equation (1). In this context, the Radon transform involves realigning and summing over x₀ all the coherent images I1-In of the object OBJ formed on detector DT by all separately activated light sources S1-Sn after they have undergone a z-dependent shift onto the detection plane DT with respect to the reference location x.

This transform—which is very fast and can be processed in real-time on standard GPUs—enables isolating, or precisely localizing, the exact plane where the object OBJ is located. The parameters for isolating a single plane different from plane at focus FP depend on the geometrical path followed by light rays from SRC to FP and are recovered through ray-tracing, as done in conventional lightfield imaging. Reported herein is, by way of example, the transformation that isolates the plane located at a distance z from the focusing element L0, in the case of the illumination scheme in FIG. 1B,

$$I ( x , {x}_{0} ) \to {I}_{z}^{′} ( x , {x}_{0} ) = I [ \frac{M}{1 - \frac{z - {z}_{0}}{L}} ( - x + \frac{z - {z}_{0}}{L} {x}_{0} ) , {x}_{0} ] . \qquad ( 3 )$$

Here, M represents the magnification of the focused imaging system, L is the illumination distance (i.e., the distance between the array of light sources SRC and the plane of the object OBJ) and the reconstruction parameter z-z0 is equal to 0 when reconstructing objects OBJ at focus (i.e., placed in the plane at focus FP), and positive (negative) for planes farther (closer) from the focusing element L0 with respect to the plane at focus FP. Regardless of the particular transformation involved, the Radon transform isolating a single object plane OBJ reads as

$${I}_{z} ( x ) = {\sum }_{all {x}_{0}} {I}_{z}^{′} ( x , {x}_{0} ) . \qquad ( 4 )$$

The intensity distribution of the reconstructed image of the object OBJ placed at distance z reconstructed by the Radon transform is

I_{z}(x)=|A(x)*D_{f(z)}(x)*P(x)|². (5)

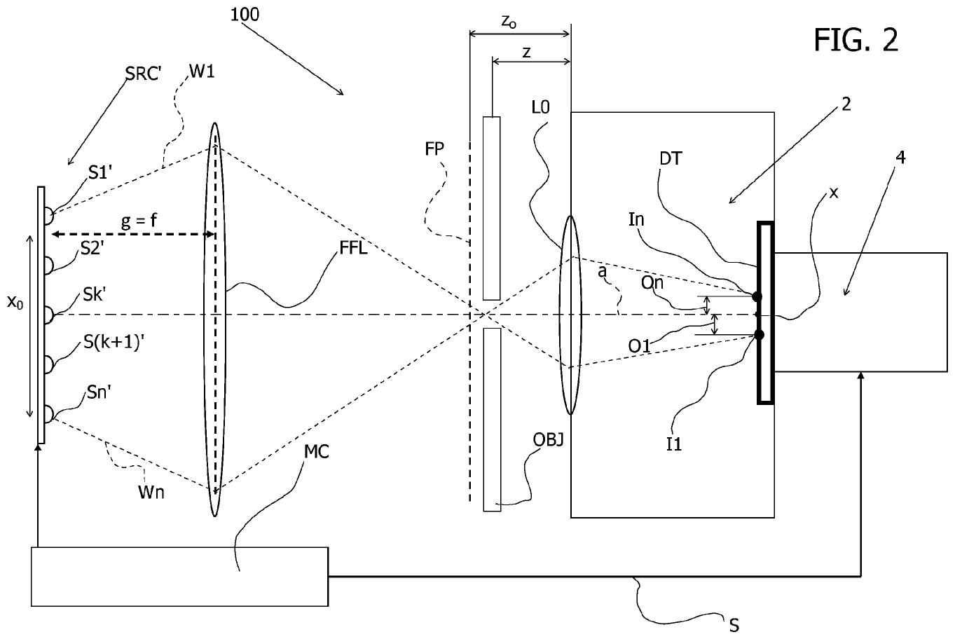

This formula has the same analytical form both in the plane-wave illuminated imaging system of the prior art (FIGS. 1A and 1B) and in the embodiments of the invention (FIGS. 2 and 3); however, the “equivalent propagation distance” f(z), which substitutes the defocusing of the object OBJ, depends on the illumination scheme and reads

$${f}_{1} ( z ) = {( \frac{1}{z - {z}_{0}} + \frac{1}{L - z + {z}_{0}} )}^{- 1} {f}_{2} ( z ) = z - {z}_{0} \qquad ( 6 )$$

$${f}_{3} ( z ) = {( \frac{1}{z - {z}_{0}} + \frac{1}{{δ}_{0} - z + {z}_{0}} )}^{- 1}$$

where the three indexes 1, 2, 3 refer, respectively, to the schemes in FIGS. 1, 2, 3. The quantity δ0 in f₃(x) represents the distance between the plane at focus FP and the plane IP where the array of light sources SRC is relayed by an imaging lens such as IL in FIG. 3.

The analytical form of the reconstructed image of Equation (5), indicates that the resolution of the image is determined by the numerical aperture of the imaging system (through P(x)) only when the object OBJ is in the plane at focus FP; hence, it is the same as in standard incoherent imaging. However, the resolution of the reconstructed image is entirely defined by diffraction (through D_{f(z)}) when the object OBJ is located in a plane different from the plane at focus FP; in this diffraction-limited regime, the resolution of the reconstructed image becomes completely independent of the numerical aperture of the imaging system.

This property has been noted by the inventors, and was otherwise overlooked or misunderstood in the prior art which is captive, in this respect, of a technical prejudice indicating the resolution of both the acquired (I2-In) and the reconstructed images as dependent from the numerical aperture NA.

In fact, as shown in FIG. 4, the scaling of the resolution in this regime is governed by a square-root law \sqrt{f(z)} for all illumination schemes of FIGS. 1, 2, 3, as opposed to the typical linear, aperture-defined, scaling of standard (incoherent) imaging (STD in the plot). The advantage of the method of the invention over standard imaging is given by this trend and by the possibility of tuning how the resolution of the final image scales with the “defocusing” (i.e., with the distance of the object OBJ from the focusing plane FP) by exploiting the dependence of the effective defocusing length f_{2,3(z)} (Equation (6)) on experimental parameters connected with the illumination scheme. This last feature is common to all of the embodiments of the invention, and is a distinguishing feature of the latter over the prior art.

In light of the new theoretical results, the scaling of the resolution with the defocusing, in the three illumination schemes of FIGS. 1A, 1B and FIGS. 2, 3, is shown in FIG. 4, which also shows a comparison with the linear NA-dependent scaling typical of standard (incoherent) imaging—STD plot. Particularly interesting is the shape of the resolution curve of the imaging system in FIG. 3. In fact, the relay lens that reproduces the source SRC close to the object OBJ identifies, through the distance δ₀, both a further plane (beside FP) where resolution is the maximum possible (diffraction limited), and a region of space, comprised between the plane FP and the plane IP where the source is relayed, where refocusing is possible with much higher resolution than in the schemes of FIGS. 1 and 2. Outside of this region, the advantage of this system tends to disappear and resolution is eventually outperformed by the system in FIG. 1, 2.

Another relevant parameter of the reconstructed images is the axial resolution, which is exactly the same as the depth of field of the standard incoherent image. This can be understood by considering that an object at axial coordinate z will be resolved not only if the aligning algorithm is applied at a position z; in fact, depending on its size, the object can still be reconstructed “sharply enough” even if the algorithm reconstructs an axial coordinate z′≠z close enough to the plane where the object is placed; the distance by which z′ is offset from z is defined by the axial resolution of the device. In fact, a range of z′ exists around the object coordinate z for which the reconstructed image is characterized by essentially the same quality of the exact reconstruction in z. This implies that the position of the object on the optical axis cannot be determined with arbitrary precision, but is determined by the axial resolution.

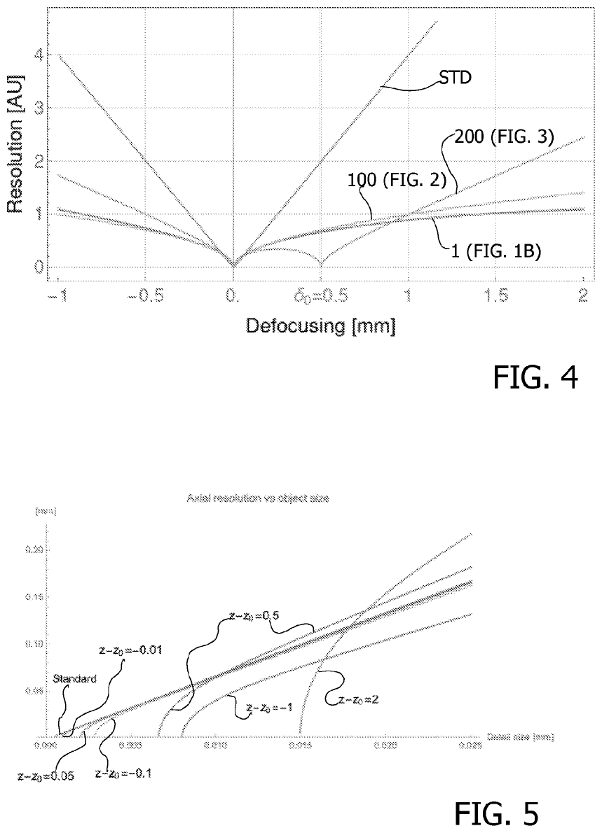

FIG. 5 shows a comparison between the axial resolution of the reconstructed image at disparate offsets from the focused plane FP (purely for exemplary purposes, the following cases are shown in the plot (sizes are in mm): z-z₀=2, z-z₀=0.5, z-z₀=0.05, z-z₀=−0.01, z-z₀=−0.1, z-z₀=−1) and standard imaging (Standard). The resolution is estimated as the axial range in which the image of a gaussian object has a width σₒᵤₜ less than double with respect to its real size σᵢₙ, that is σₒᵤₜ≤2σᵢₙ. The axial resolution of standard imaging depends on the object size and is inversely proportional to the numerical aperture of the imaging system (the larger the aperture, the finer the resolution). In the system and method of FIGS. 1A, 1B, which was chosen as the example benchmark from which FIG. 5 has been obtained, the axial resolution of the reconstructed image has a very similar trend to standard incoherent imaging for object size much larger than the minimum resolution (Rayleigh limit), showing that the possibility of resolving the object OBJ on the optical axis indeed depends on the numerical aperture of the imaging system. The most evident difference with standard incoherent imaging is that, depending on the axial location of OBJ (z-z₀), the axial resolution might not be defined even for object size larger than the Rayleigh limit. This property is explained by the resolution curves of FIG. 4. In fact, the minimum resolvable object size as a function of its axial location is not given by the Rayleigh limit, as in standard incoherent imaging, but by the curves characterized by a square-root scaling. Thus, for any given axial location of the object OBJ, the minimum object size that can be resolved is the value of the resolution curves at that axial position; such minimum size determines the left boundary of the domain of the curves in FIG. 5. As the object increases in size, however, the axial resolution curves tend to the incoherent linear scaling.

Thus far, the features of the imaging systems of FIGS. 1-3 has been described purely from a mathematical point of view when illuminated by a set of point-like sources. However, from a practical point of view, the point-like nature of the source of illumination is not strictly required, since the imaging properties described so far are a consequence of illuminating the object with transversally coherent light, and not of the point-like nature of the sources themselves. In fact, whereas a point source always guarantees that the emitted wavefronts are coherent, the size of the light sources S1-Sn can be finite provided their coherence area on the object plane is larger than the object itself. If this condition is satisfied, the optical performance of both the prior art systems and the systema according to the invention is described by FIG. 4.

The case of light sources characterized by non-negligible transverse size is the most appealing for applications of interest for the invention, since this is almost always the case when the light source SRC is implemented through commercially available devices such as LED arrays.

If the source has a transverse size w, the coherence areas aᵢ of the light emission onto the object OBJ in the imaging systems of FIGS. 1, 2, 3 are, respectively (the index is representative of the figure),

a₁=\sqrt{(k NA₁)⁻¹}

a₂=\sqrt{(k NA₁)⁻²+(k NA₂)⁻²+(4k²w NA₁NA₂)⁻²} (7)

a₃=M′(k NA₂)\sqrt{1+(4k w NA)⁻²}

where k is the wavenumber of the light emission, NA₁ is the numerical aperture of the light source, defined as the ratio between the source radius and the illumination distance (i.e. the distance between the source array SRC and the object OBJ in FIG. 1, the source array SRC and the lens FFL in FIG. 2, the source array SRC and the lens IL in FIG. 3), and NA₂ is the numerical aperture of an imaging system FFL, IL in the systems of FIGS. 2, 3, defined as the ratio between its aperture (IL and FFL are preferably lenses) and the distance of such lenses from the source SRC. Further details of the setup of the systems in FIGS. 2, 3, will be provided in the following.

Another important fact deriving from the new theoretical assessment is that varying the light source location x₀ is not instrumental to changing the inclination of a plane wave emanating from the (point-like) light source, as understood in the prior art. In fact, the information required for 3D reconstruction is obtained regardless of the illuminating system, with optical performance that varies with the illumination scheme as described by FIG. 4. The benefits of this aspect are not limited to tailoring alternative system setups wherein the image of the light source can be relayed close to the object (FIG. 3), but also strongly relieve constraints on the minimum illumination distance in FIG. 1, which must be quite large only if plane wave illumination is required.

The disclosure of the prior art system and method in the foregoing, as well as the additional disclosure of features and aspects of the systems overlooked or misunderstood altogether in the prior art, and further all of the aspects of the embodiments of the invention (system setups of FIGS. 2, 3) anticipated by the foregoing disclosure, shall be intended as an integral part of the disclosure of embodiments of the invention that will be provided in the following, which also takes benefit from specific paragraphs below. For this reason, outside of the specific numbering of the systems of the invention as 100, 200, the reference numbers already used in respect of system 1 are maintained unchanged, and so is the technical function underlying the same (and the relevant disclosure thereof already provided in the foregoing). A fundamental difference of systems 100, 200 as compared to system 1 is that the array of light sources—now referred to as SRC′—may not necessarily be made of light sources of plane waves. Accordingly, light sources S1′, S2′, Sk′, S(k+1)′, Sn′ in the array SRC′ are not required to satisfy any specific condition or to feature specific inherent properties (i.e. being a source of plane waves).

Reference number 100 in FIG. 4 designates an imaging system according to first embodiments of the invention, while reference number 200 designates an imaging system according to second embodiments of the invention. A common feature between the first and second embodiments is the provision of an imaging device between the array of light sources SRC′ and the imaging unit 2, whereby—in use—the imaging device is located between the array of light sources SRC′ and the object OBJ. Examples of such imaging devices may comprise lenses and mirrors (in combination or in alternative).

The system 100 in FIG. 2 differs from the system 1 in FIG. 1 in that it further comprises a far-field lens FFL of focal distance f as the imaging device between the array SRC′ and the object OBJ. More specifically, the far-field lens FFL is arranged between the array of light sources SRC′ and the focusing element L0 of the imaging unit 2, with the far-field lens being arranged at the respective focal distance f from the array of light sources SRC′. System 100 allows illuminating the object OBJ with plane waves even when it is essentially non-feasible to position the array of light sources SRC′ at a distance from the object OBJ large enough to result in the light sources SRC′ behaving as point-like light sources.

The system 200 in FIG. 3 differs from the prior art system 1 in that it includes an imaging lens IL as the imaging device between the array SRC′ and the object OBJ. More in detail, the imaging lens IL is arranged between the array of light sources SRC′ and the focusing element L0 of the imaging unit 2, the imaging lens IL being configured for imaging onto a plane IP the plane of the array of light sources SRC′. The imaging lens IL is in particular arranged at a distance g from the plane of the array of light sources SRC′ and configured to image the plane of the array of light sources SRC′ at a plane IP located at a distance f*g/(g−f) from the imaging lens IL itself. References S1′-Sn′ in parentheses designate the images of the sources S1′-Sn′ on the plane IP.

In other terms, systems 100 and 200 may be regarded as individual setups of one and the same imaging system, herein the array of light sources SRC′ is imaged by the imaging device FFL or IL in the region where the object OBJ is located. In fact, both systems 100 and 200 are bound by the thin lens equation

(1/g)+(1/h)=(1/f)
where “g” and “h” are the object- and image-distances relative to the imaging device FFL or IL, and “f” is the focal length of the imaging device FFL or IL, which essentially corresponds to a relay lens. The system 100 is representative of the specific case g=f, i.e. an asymptotic condition wherein relay image, namely the image of the array SRC′ forms at infinite distance from the imaging device FFL. System 200 is, instead, representative of a more general condition wherein g #f, whereby the plane of the array SRC′ is imaged in the plane IP at a distance h=f·g/(g−f) from IL.

The plots in FIG. 4 show the optical performance of the three illumination schemes of FIGS. 1A and 1B (label “1”), 2 (label “100”), and 3 (label “200”), quantified as a resolution [AU] as a function of axial defocusing dependence [mm]. The labels are further supplemented, in parenthesis, by the title of the figures they refer to.

FIG. 4 shows that all three system setups (1, 100, 200) ensure diffraction-limited resolution in the plane at focus (z=0)—note that the reproduction scale of FIG. 4 does not allow a meaningful representation of the resolution limit of the systems 1, 100, 200 (A/NA, with A being the light wavelength) because a representation of the latter in such a scale would hardly be visible on the plot.

As out-of-focus planes are investigated, marked differences appear:
imaging systems 1 and 100 show very similar trends: the refocusing range increases monotonically with the distance from focus, with a behaviour that is well-approximated by a square-root law,
imaging system 200 shows a different trend, having a second high-resolution plane at the axial coordinate of the plane IP where the image of the array SRC′ is relayed by the imaging device IL, acting as a relay lens proper. The lower plot also shows that for an extended reconstruction range along the optical axis, the advantage of system 200 over systems 100 and 1 is gradually reduced.
   In this regime, system 200 shows a linear scaling of the resolution curves, which translates into poorer imaging performance as soon as farther planes are considered.

From the plots of systems 200 and 100, one may infer that by sweeping the range g≥f (which determines where the image of the array SRC′ is formed), the optical performance of the system can be fine-tuned to the desired specifications, especially with the system 200 and the possibilities offered by the second high resolution plane are of great interest in the domain of microscopy.

All of the systems 100, 200 disclosed herein can be readily practised for multispectral and multicolor measurements of an object OBJ with frequency-dependent absorption profile. Multi-spectral measurement can be performed by:
i) illuminating the object OBJ with white or broadband light (purely by way of example, white LEDs) characterized by an emission spectrum covering the whole spectral region of interest. In such embodiments, the image acquisition device 4 of the imaging unit 2 shall be embodied as a multi-spectral camera capable of decomposing the light spectrum into the required spectral components. As an example, an RGB measurement can be obtained by illuminating the object OBJ with an array of white LEDs and measuring each image corresponding to all illumination coordinates with a RGB camera 4,
or, alternatively,
ii) for each light source position on the array SRC′, illuminating the object OBJ sequentially at one wavelength (of a RGB spectrum, for example) at a time. This method does not require a multispectral image acquisition device 4 in the imaging unit 2, provided the sensitivity of the latter at different wavelengths is known. For example, an array of RGB LEDs can be used as the illumination source; each LED of the array is programmed to sequentially illuminate the object OBJ with red, green, and blue light (i.e. at the corresponding wavelengths), capturing (three) different exposures under different wavelength illumination conditions with a grayscale camera. The real color map for each LED (white balancing) is then reconstructed through the known frequency response of the image acquisition device 4.

In summary, a key difference between systems 100, 200 according to the invention and the prior art represented by FIGS. 1A and 1B lies in the parameters relevant to image reconstruction. More specifically, while in the prior art it is essential to have plane waves hitting the object (i.e. to have light sources in the array SRC complying with specific conditions) and to know the illumination angle under which the object is hit by the activated light source in the array, in the systems 100, 200 according to the invention it is no longer necessary to hit the object OBJ with plane waves, nor is it necessary that the illumination angle under which the object OBJ is hit by the emission from the light source be known.

The method according to the invention (and the systems 100, 200 accordingly) only requires that the position x₀ of the activated light sources S1′, S2′, Sk′, S(k+1)′, Sn′ (collectively referred to as S1′-Sn′) in the array SRC′ is known when detecting the spatial location at which images I1-In of points of the object OBJ form, through the imaging unit 2 on the detector DT owing to the same activated light source in the array, as well as detecting the shift (O1-On) of each detected spatial location with respect to the reference spatial location x. In fact, the pattern through which the light sources in the array SRC′ are activated inherently result in a variation of the position of the (currently) activated light source in the array, this being the relevant input data to the system and method according to the invention. An illumination angle no longer needs to be known or determined to reconstruct the image.

Naturally, while the principle of the invention remains the same, the details of construction and the embodiments may widely vary with respect to what has been described and illustrated purely by way of example, without departing from the scope of the present invention.

1. An imaging method, comprising:
providing an array of light sources, each light source of the array is configured for an output of a light emission,
providing an imaging unit including a focusing element and a detector configured for detecting the light emissions from the light sources of the array through the focusing element,
providing an object between the detector and the array of light sources,
providing an imaging device between the array of light sources and the object,
operating the array of light sources by activating the light sources of the array according to a sequential pattern, whereby a position of an activated light source of the array with respect to the object is varied with activation of the light sources according to said sequential pattern,
imaging the array of light sources through said imaging device while operating the array of light sources,
detecting a spatial location at which images of points of said object form under disparate positions of the activated light sources of the array, and through the imaging device, on said detector, and a shift of each detected spatial location with respect to a reference spatial location, and
reconstructing an image of the object by aligning the images of points of said object formed under the disparate positions of the activated light sources of the array by offsetting the shift of each detected spatial location with respect to the reference spatial location.

2. The method of claim 1, wherein each light source is a source of spatially coherent light.

3. The method of claim 2, wherein each light source is a source of transversely coherent light.

4. The method of claim 1, wherein the reference spatial location is an intersection of an optical axis of an imaging system with said detector.

5. The method of claim 1, wherein the array of light sources is a linear array.

6. The method of claim 1, wherein the array of light sources is a matrix array.

7. The method of claim 1, wherein said operating the array of light sources comprises, in alternative,
i) illuminating the object with white or broadband light sources having an emission spectrum covering a spectral region of interest, wherein the imaging unit comprises a multi-spectral camera configured for decomposing an illumination spectrum into spectral components,
ii) illuminating the object sequentially at one wavelength of a light spectrum at a time, wherein each light source of the array is configured to sequentially illuminate the object with light having a respective wavelength, and wherein the imaging unit comprises a grayscale camera configured for capturing different exposures under different wavelength illumination conditions.

8. An imaging system, comprising:
an array of light sources, each light source of the array is configured for an output of a light emission,
an imaging unit including a focusing element and a detector configured for detecting the light emissions from the light sources of the array through the focusing element,
an imaging device between the array of light sources and the imaging unit, wherein the imaging device is arranged so to be located, in use, between the array of light sources and an object,
a control unit configured for operating the array of light sources by activating the light sources of the array according to a known sequential pattern, whereby a position of an activated light source of the array with respect to the object is varied with activation of the light sources of the array according to said known sequential pattern,
wherein the control unit is further configured for detecting a spatial location at which images of points of said object form under disparate positions of the activated light sources of the array through the imaging device and through the focusing element on said detector, and for determining a shift of each detected spatial location with respect to a reference spatial location,
and further wherein the control unit is configured for reconstructing an image of the object by aligning the images of points of said object formed under the disparate positions of the activated light sources of the array by offsetting the shift of each detected spatial location with respect to the reference spatial location.

9. The system of claim 8, wherein each light source is a source of spatially coherent light.

10. The system of claim 9, wherein each light source is a source of transversely coherent light.

11. The system of claim 8, wherein the reference spatial location is an intersection of an optical axis of an imaging system with said detector.

12. The system of claim 8, wherein the array of light sources is a linear array.

13. The system of claim 8, wherein the array of light sources is a matrix array.

14. The system of claim 8, wherein said imaging device comprises a far-field lens arranged between the array of light sources and the focusing element of the imaging unit, the far-field lens being arranged at a respective focal distance from the array of light sources.

15. The system of claim 8, wherein said imaging device comprises an imaging lens arranged between the array of light sources and the focusing element of the imaging unit, the imaging lens having a focal length and being configured for imaging a plane of the array of light sources at another plane located at a predetermined distance from the imaging lens.
